(19) United States
(12) Patent Application Publication
(10) Pub. No.: US 2025/0363239 A1
(43) Pub. Date: Nov. 27, 2025

(54) DATA DISCOVERY FOR DATA PRIVACY MANAGEMENT

(71) Applicant: DataGrail, Inc., San Francisco, CA (US)

(72) Inventors: Ignacio Zendejas, Fremont, CA (US); Cathryn J. Polinsky, San Mateo, CA (US); Daniel Barber, San Francisco, CA (US)

(21) Appl. No.: 18/670,116

(22) Filed: May 21, 2024

(51) Int. Cl. G06F 21/62; G06F 21/44

(52) U.S. Cl. CPC G06F 21/6245; G06F 21/44

(57) ABSTRACT

Disclosed are some techniques for implementing a data discovery agent in a network associated with a customer organization of a data privacy management system. Some implementations relate to one or more connections with one or more data sources storing private data of the customer organization. The one or more data sources can be scanned to obtain scanned data from the private data. The scanned data can be processed, including anonymizing the scanned data, to obtain preprocessed data for use by one or more classification operations. The preprocessed data can be shared with the data privacy management system. One or more classification promotion operations can be performed on classified data elements.

### COPYRIGHT NOTICE

A portion of this disclosure contains material, which is subject to copyright protection. The copyright owner has no objection to the facsimile reproduction by anyone of this disclosure as it appears in the United States Patent and Trademark Office patent file or records but otherwise reserves all copyright rights whatsoever.

### TECHNICAL FIELD

This disclosure generally relates to data privacy management in data networks. More specifically, this disclosure describes techniques for data discovery in the context of data privacy management environments.

### BACKGROUND

The subject matter discussed in this background should not be assumed to be prior art. Similarly, a problem mentioned in this background or associated with the subject matter in this background should not be assumed to have been recognized in the prior art.

Information privacy generally relates to the privacy of personal information and may be associated with the collection, storage, use and sharing of the personal information. Personal information may be collected with or without knowledge of the subjects of the personal information. There are privacy laws and regulations that govern the subjects' rights to request their personal information, to have the information removed, to control the sale of the information and to prohibit the disclosure or misuse of the information, among other rights. Organizations which collect personal information from subjects are required to disclose the nature of their practices when requested by legal authorities. For example, in California, state privacy laws require websites which collect personal information of subjects to disclose the types of information collected, the types of 3rd parties to which the information is delivered, etc.

### BRIEF DESCRIPTION OF FIGURES

The included figures are for illustrative purposes and serve only to provide examples of possible structures and operations for some disclosed implementations of systems, apparatus, processes and computer program products. These figures in no way limit any changes in form and detail that may be made by one skilled in the art without departing from the spirit and scope of some disclosed implementations.

FIG. 1 shows an example of a data privacy management environment 100 in which examples of data discovery flows can be performed.

FIG. 2 shows another example of a data privacy management environment 200 in which examples of data discovery flows can be performed.

FIG. 3 shows an example of a data discovery flow 300 including one or more processes for data privacy management.

FIG. 4A shows an example of a preprocessing process 400A.

FIG. 4B shows an example of an anonymization process 400B.

FIG. 5 shows an example of a data classification dashboard 500 in the form of an interactive graphical user interface (GUI).

FIG. 6 shows an example of a classification details dashboard 600 in the form of an interactive GUI.

### DETAILED DESCRIPTION

Examples of systems, apparatus, processes and computer program products including non-transitory computer-readable media according to some disclosed implementations are described. These examples are provided to add context and aid in the understanding of some implementations. It will be apparent to one skilled in the art that some implementations may be practiced without some or all of the described specific details. In some implementations, certain structures and operations are not described in detail to avoid unnecessarily obscuring the description. Other applications are possible, such that the following examples should not be taken as definitive or limiting either in scope or setting.

References are made to the accompanying figures, which form a part of the description and in which are shown, by way of illustration, some specific implementations. Although these implementations are described in sufficient detail to enable one skilled in the art to practice the disclosed implementations, it is understood that these examples are not limiting. Some other implementations may be used, and changes may be made without departing from their spirit and scope. For example, operations of processes shown and described herein are not necessarily performed in the order indicated. It should also be understood that the processes may include more or fewer operations than are indicated. In some implementations, operations described herein as separate operations may be combined. Conversely, what may be described herein as a single operation may be implemented in multiple operations.

One or more of the disclosed examples may be implemented in numerous ways, including as a process, an apparatus, a system, a device, a non-transitory computer-readable medium storing computer-readable program instructions or computer program code, a computer program product including a non-transitory computer-readable medium and any combination thereof.

The subject matter described herein may be implemented in the context of any computer-implemented system or systems, such as a server system, a client system, a software-based system, a database system, a multi-tenant system and any combination thereof. Moreover, the described subject matter may be implemented in connection with two or more separate and distinct computer-implemented systems that cooperate and communicate with one another, such as a data privacy management system and a customer network. In some implementations, a third separate and distinct computer-implemented system is in a 3rd party platform, which cooperates and communicates with the data privacy management system and the customer network.

Described herein are some examples of systems, apparatus, processes and computer program products implementing some techniques and other aspects of data discovery in conjunction with data privacy management. Such data discovery can be implemented to uncover a customer organization's privacy, security and compliance risk by classifying data stored within various customer-related data sources, while reducing risk to the customer organization in some implementations. Some examples of the disclosed data discovery techniques can provide a more accurate and complete assessment of the customer organization's privacy risk. In some implementations, privacy managers can be provided with automated and up-to-date inventory-related system reports and informed impact assessments. Comprehensive access and deletion requests can be provided. Risk reduction can be shifted to be more proactive with better informed policies and controls around a customer organization's data processing.

In some implementations, data managed by or otherwise associated with a customer organization can be detected in structured, semi-structured and unstructured systems. A data privacy management system servicing the customer organization can help the customer organization protect sensitive data from compromise by identifying and categorizing such data for structured data sources (e.g., relational databases) and schema-less systems (e.g., NoSQL stores). In some implementations, to keep up with evolving compliance laws and data governance regulations, the data privacy management system classifies data from a customer organization's data sources and maps the data to categories. Some of the disclosed techniques can facilitate auto-populating privacy deliverables like data protection impact assessments (DPIAs), records of processing activities (RoPAs), subject requests, etc.

Some of the disclosed implementations provide or enhance security to avoid adding to a customer organization's privacy and security risk. For instance, some implementations can prevent direct connection to a customer organization's client systems and database systems from outside of the customer network. Thus, compromise of the data privacy management system by a bad actor would not automatically lead to access of a customer organization's internal systems.

Some implementations provide privacy by design, in which data collected or processed by the data privacy management system is anonymized, so the data does not identify an individual, even when combined with other data. In some implementations, data sampled from a customer organization's data sources is intentionally processed in a customer organization's network/virtual private cloud. Collected data can be used to train data classification models in some implementations. That is, collected data, even when anonymized, can still provide enough information along with metadata to accurately classify the data. In some implementations, classification of data is performed by the data privacy management system rather than in a customer network to provide iteration on the models without having to require that customer organizations perform updates. For example, anonymized data can be used to improve the models, by way of gathering an anonymized knowledgebase.

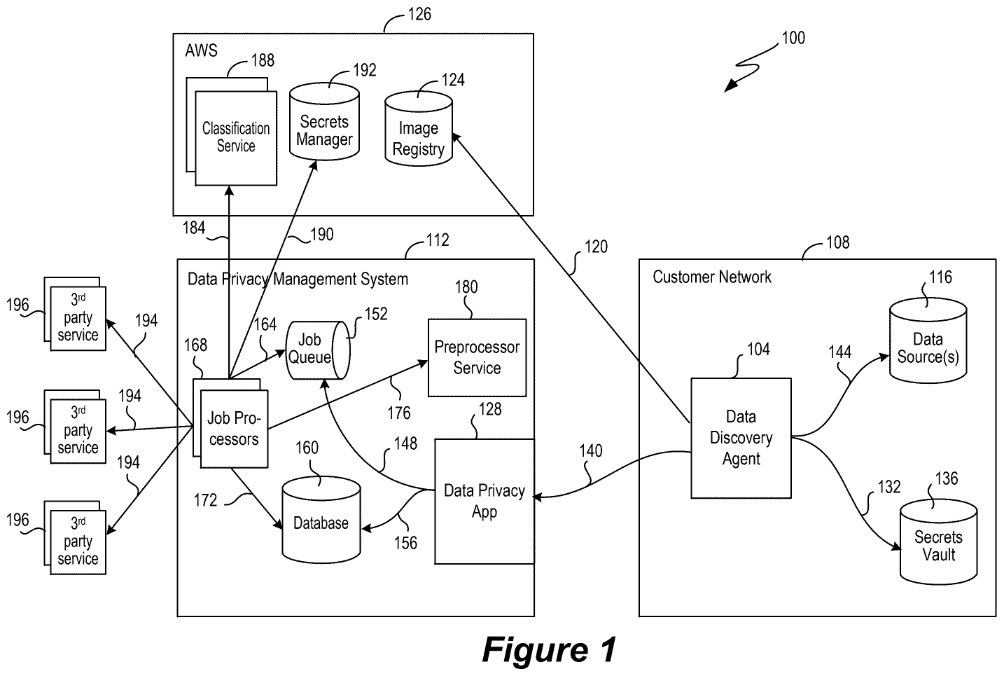

FIG. 1 shows an example of a data privacy management environment 100 in which examples of data discovery flows can be performed. In FIG. 1, a data discovery agent 104 is implemented in a customer network 108, which is a data network including one or more client systems used by or otherwise servicing a customer organization, which is a customer of a data privacy management system 112 including one or more server systems. A data discovery agent is referred to herein as an agent, and a data privacy management system is referred to herein as a data privacy system. In customer network 108, agent 104 is deployed to establish and/or use one or more connections with any of a variety of data sources 116 storing private data of the customer organization. Data sources 116 can be internal and/or external to customer network 108. For instance, data sources 116 can include internal or 3rd party data services, databases, data lakes and/or data warehouses. The connections between agent 104 and data sources 116 provide communication between agent 104 and data sources 116. As explained in greater detail herein, in some implementations, agent 104 is deployed in customer network 108 and executed to: scan one or more of data sources 116 to obtain scanned data from the private data, preprocess the scanned data to obtain preprocessed data for use by one or more classification operations, and share the preprocessed data with data privacy system 112.

To protect a customer organization's data, an agent such as agent 104 can be deployed securely within a customer organization's private networks, which are unreachable via the public Internet. Agent 104 can be configured to securely connect to data sources 116 with read-only privileges and without sharing secrets or credentials with data privacy system 112. Agent 104 is configured to retrieve schemas and other metadata, and scan and preprocess data. In some implementations, the preprocessed data shared by agent 104 with data privacy system 112 includes metadata, classification features and anonymized data. As described in greater detail herein, agent 104 can share data with a data privacy application programming interface (API) associated with data privacy system 112. In some implementations, the agent is statically configured (rather than providing a dynamic configuration option) before being executed as one or more tasks. These tasks can be scheduled to be run using a customer organization's desired containerization platform.

In some implementations, two or more agents can be deployed to avoid eroding firewalls and/or centralizing data. For instance, at least one agent can be deployed per customer network and/or subnetwork. In some other implementations in which a customer organization is at least partially hosted on a 3rd party platform such as Amazon Web Services (AWS), the data discovery agent can run on AWS Fargate or other suitable serverless computing engine.

In FIG. 1, data privacy system 112 can be implemented with one or more server systems or other computing systems. As explained in greater detail herein, data privacy system 112 can be configured to: obtain data elements shared by agent 104, perform one or more classification operations on the shared data elements to obtain classified data elements, and perform one or more classification promotion operations on the classified data elements to obtain promoted data elements. Classification promotion can include displaying results on computing devices of a customer organization's users.

In FIG. 1, a variety of data discovery-related flows can be performed. Such flows often are applicable to a customer organization's internal systems as well as to integrated 3rd party systems, where customers can store personal data.

In FIG. 1, at 120, agent 104 pulls an image from an image registry 124 such as an elastic container registry (ECR). In this example, image registry 124 is hosted by a 3rd party platform 126 such as AWS. In some implementations, this image contains a python process executable by agent 104 to: connect to one or more of data sources 116, sample data from data sources 116, preprocess the sampled data, and post the preprocessed data to a data privacy app 128 of data privacy system 112.

In some examples, data privacy app 128 can be implemented as a web application configured to serve web and API requests, and data privacy app 128 can run on a serverless computing engine such as AWS Fargate. At 132, agent 104 obtains a reference such as an acquirer reference number (ARN) to a location in a vault, such as secrets vault 136, which stores an API key provided by data privacy system 112. The API key can be used to authenticate and authorize agent 104. Secrets vault 136 can be a customer organization's preferred secrets storage repository or service. Also or alternatively, in an AWS implementation, the AWS secrets manager can serve as secrets vault 136.

In FIG. 1, at 140, agent 104 can use the API key to communicate with data privacy app 128 and exchange various items of information. For instance, agent 104 can pull, from data privacy app 128, connection configuration information such as: data source name, data source universal unique identifier (UUID) and/or data source vault reference. In FIG. 1, at 140, agent 104 also can post, to data privacy app 128, information including preprocessed data as well as metadata such as schema information for a given data source. In some implementations, agent 104 also can pull, from data privacy app 128, additional configuration information such as scheduling data indicating when to scan data sources. In some implementations, agent 104 also may post, to data privacy app 128, a connection status for each data source.

In FIG. 1, at 144, agent 104 can connect to configured data sources 116 using credentials stored in secrets vault 136 and can scan data sources 116. Data pulled by agent 104 from one or more of data sources 116 can include metadata identifying databases, tables, table names, columns, field names, field types, data types, record counts and foreign relationships by way of illustration. In some implementations, scanning data sources 116 includes sampling data. In one illustrative example, 20,000 database records in data sources 116 can be sampled.

In FIG. 1, at 140, preprocessed data generated by agent 104 from the scanned data can be shared by agent 104 with data privacy app 128. In this example, at 148, data privacy app 128 enqueues this shared data, which includes data elements, in a job queue 152 such as a Redis queue as part of one or more jobs, by way of illustration.

In FIG. 1, at 156, jobs processing queued data elements can store related information in a database 160, for instance, under DataElement objects. Data privacy system 112 can use such a database 160 to store various application data. At 164, job processors 168 connect to job queue 152 to pull outstanding enqueued jobs, which often include metadata and schema information as examples of shared data elements. At 172, job processors 168 connect to database 160 to store and retrieve preprocessed data, as described in greater detail herein.

In some alternative 3rd party integrations, at 176 of FIG. 1, job processors 168 can make requests to a preprocessor service 180 to take sampled or otherwise scanned data supplied by agent 104 and convert such scanned data to preprocessed data. Thus, in such part integrations, agent 104 can be configured to refrain from preprocessing the scanned data to and instead share the scanned data with data privacy system 112. For example, preprocessor service 180 can be implemented as a microservice running on AWS Fargate that allows data privacy system 112 to preprocess data sampled from 3rd party services. In such 3rd party integrations, at 184, job processors 168 can make requests to a classification service 188 in order for classification service 188 to classify data elements. In this example, classification service 188 is hosted by 3rd party platform 126. For instance, classification service 188 can be in the form of a microservice running on AWS Lambda. In some other implementations, classification service 188 is implemented as part of data privacy management system 112 rather than on 3rd party platform 126.

In FIG. 1, for 3rd party integrations, at 190, data privacy system 112 is able to use existing integration configurations to pull encrypted secrets from a secrets manager 192 hosted by 3rd party platform 126. In this example, job processors 168 make a request to retrieve, from secrets manager 192, a symmetric encryption key, which can be used to decrypt secrets stored in database 160, in order to make authorized requests. In some optional 3rd party integrations, at 194, job processors 168 connect to any of 3rd party services 196 to sample data. In such implementations, this sampled data from 3rd party services 196 gets fed to preprocessor service 180, and such sampled data is temporarily stored in memory in some implementations. Thus, in these 3rd party integrations, agent 104 is optional, since the scanned data is pulled from services 196, and preprocessing of the scanned data is performed by preprocessor service 180.

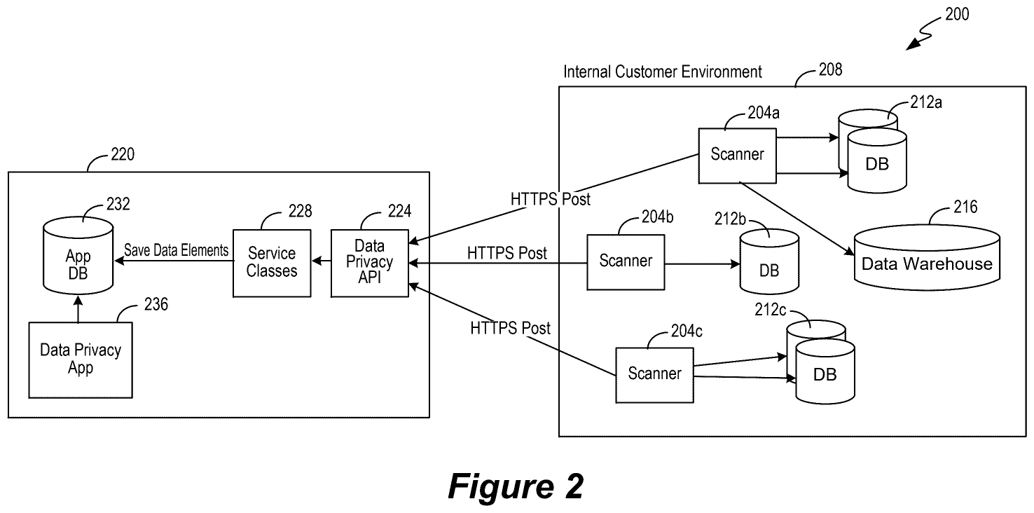

FIG. 2 shows another example of a data privacy management environment 200 in which examples of data discovery flows can be performed. A data discovery agent such as agent 104 of FIG. 1 can be implemented as a docker container running in a customer network. In the example of FIG. 2, the data discovery agent is implemented to include a set of containerized scanners 204a-c, which can run in an internal customer environment 208. Scanners 204a-c can be containerized applications that run on a private cloud or public cloud of customer environment 208. Scanners 204a-c can directly connect with the customer organization's data sources and scan the data sources. In some implementations, the data discovery agent can then preprocess scanned data for classification purposes and send the preprocessed data to a data privacy management system as further described herein.

In FIG. 2, the data sources include customer databases 212a in communication with scanner 204a, customer database 212b in communication with scanner 204b, customer databases 212c in communication with scanner 204c, as well as a customer data warehouse 216 in communication with scanner 204a. Databases 212a-c and data warehouse 216 are illustrative; various data sources associated with a customer organization can be used. Examples of data sources include operational SQL systems such as PostgreSQL, MySQL, and Microsoft SQL servers. Other examples of data sources include NoSQL systems such as DynamoDB, S3, and MongoDB, as well as SQL-based analytical systems such as Redshift, BigQuery, and Snowflake. In some implementations, it is desirable to scan canonical systems where data is collected, often in the form of operational SQL systems and NoSQL systems, before scanning analytical systems. This is because canonical systems often are more important to running customer-facing applications. By starting with canonical systems, in some implementations, visibility into a customer organization's inherent privacy risk can be provided without having to scan analytical systems, which often have multiple variations of the same data. Following up with analytical systems provides that inferred or predicted personal data also is captured and reported accurately, for instance, when it is desirable to predict a certain category of personal data from data captured in upstream canonical systems.

In FIG. 2, each scanner can make connections with out-of-the-box database systems such as PostgreSQL, MySQL, and Snowflake. New connectors can be added as desired. For proprietary systems, a codebase includes extendible interfaces to develop custom connectors. In some implementations, each data source from which a scanner collects data is, in some implementations, previously registered with the data privacy management system such as system 112 of FIG. 1. In this way, system 112 can keep track of where data elements are coming from, what entity or entities own the data elements, and how the data elements are being collected. The data source is also used to determine which system report, if any, will be updated to include classified data elements.

As referred to herein, a data element often is a smaller or smallest representation of data to be classified. For example, a data element for a relational database may be a single column and the column's associated metadata. Each data element can map to many classified data elements since some data elements, like JSONB or text, may contain more than one type of personal data. In some instances, personal data includes personally identifiable information (PII). A classified data element represents the classification of a data element. The classified data element can store information about classification operations and/or a classification process including the classification operations. For personal data, a reference to a data category also can be stored. In some implementations, this data category can later be used to update a system report for a customer organization's inventory item identified through a given data source.

In some implementations, at least some modules of a data privacy system such as system 112 of FIG. 1 can be implemented in a virtual private cloud (VPC) 220 of FIG. 2. In the example of FIG. 2, VPC 220 includes service classes module 228, which is configured to save data elements in an app database 232 of VPC 220. In this example, VPC 220 also includes a data privacy app 236. VPC 220 further includes a data privacy API 224, with which scanners 204a-c communicate. API 224 is designed and configured with flexibility, and detailed specifications can be provided upon request to a customer organization to allow proprietary client systems to be built. In FIG. 2, when information such as metadata and anonymized sampled data are retrieved by a data discovery agent in customer environment 208, the agent securely posts such data over HTTPS to API 224. Thus, the data privacy system can classify the posted data and associate classified data with a customer's internal systems reports, which in turn can inform RoPAs, privacy impact assessments and more. Thus, the data privacy system is able to aggregate information across any number of systems to give a customer organization a holistic view of the customer's inherent privacy risk.

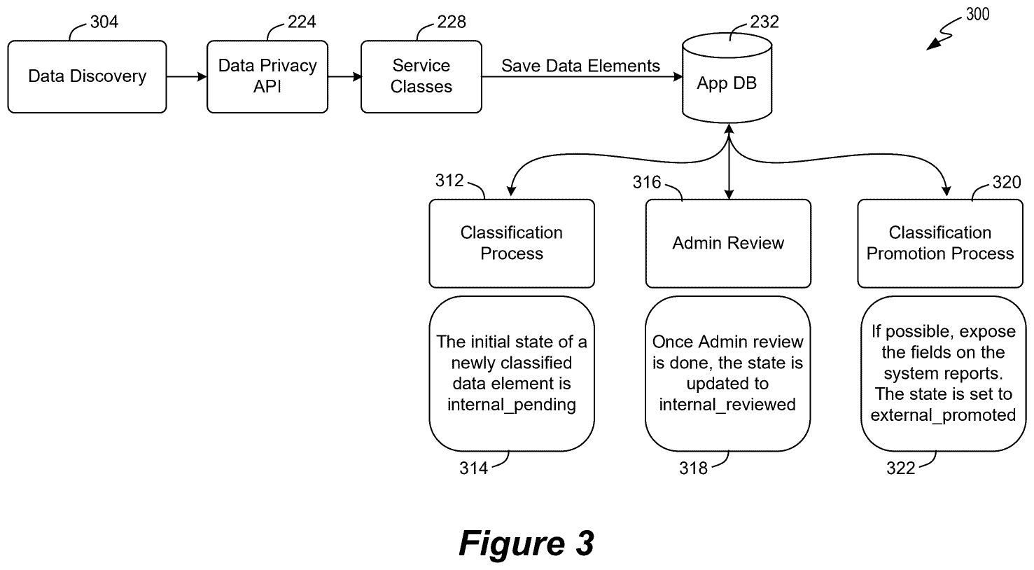

FIG. 3 shows an example of a data discovery flow 300 including one or more processes for data privacy management. FIG. 3 is described with reference to FIG. 2. In FIG. 3, a data discovery agent 304 is connected to data sources in a customer network, as further explained herein, to perform processing operations such as retrieving metadata, sampling data, preprocessing data, and posting preprocessed data to an endpoint such as API 224 shown in FIGS. 2 and 3. As further described herein, in some implementations the preprocessing of data can include transforming the data, for instance, by encoding and hashing the data.

In FIG. 3, data elements saved to app database 232 by service classes module 228 are initially unclassified. These data elements can be retrieved from app database 232 for a classification process 312 to be performed. For example, as part of classification process 312, classification models can be implemented to map, for instance, thousands of data elements to a few dozen categories. In some implementations, operations of classification process 312 are structured in a two-phased approach. First, data in a set of canonical data systems is classified. During this first phase, in some instances, the data privacy system may request secure and temporary access to a sample of raw data to train the classification models. Data from sandboxes is recommended where possible. Once fine-tuned, as part of phase two, the data privacy system classifies new data on an ongoing basis based on a customer organization's configuration. This configuration can be updated, for instance, at a monthly or quarterly cadence, often depending on a customer organization's preferences.

In FIG. 3, newly classified data elements produced by classification process 312 are designated as having a state of internal_pending at 314. In some implementations, an administrative review 316 can be performed on the newly classified data elements for correctness. Once the review has been completed, the state of the classified data element can be automatically updated to internal_reviewed at 318.

In FIG. 3, a classification promotion process 320 picks up any classified data elements having the internal_reviewed state and promotes such data elements to have an external_promoted state at 322. Classification promotion process 320 includes one or more operations responsible for finding, retrieving and promoting any internal_reviewed classified data elements. In some implementations, classification promotion process 320 also is configured to expose any predicted fields on the customer organization's associated system report. In some other implementations, administrative review 316 is omitted, in which case classification promotion process 320 is configured to retrieve and promote newly classified data elements, e.g., those data elements having the internal_pending state.

In some implementations, preprocessed data is stored by a data privacy system in an appropriate database or other repository. This preprocessed data can be later retrieved and used to help review classifications and equip machine learning (ML) modules to tune classification models.

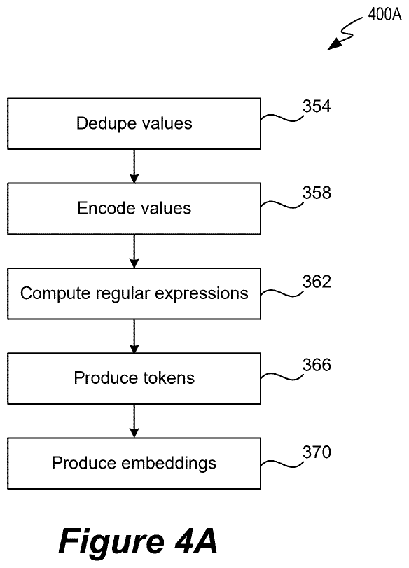

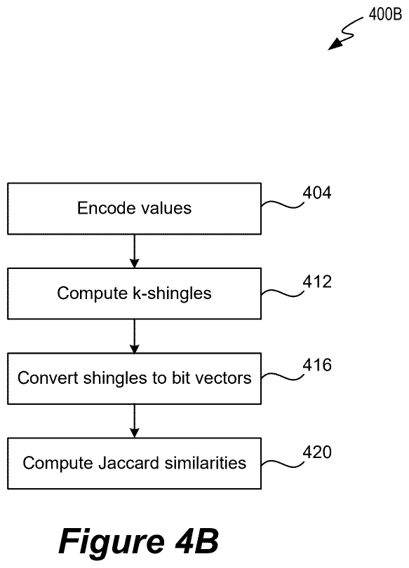

In some implementations, preprocessed data is derived by a data discovery agent or by a preprocessor service using the following operations. FIG. 4A shows an example of a preprocessing process 400A. In the example of FIG. 4A, for a given data element, values in the data element are deduped at 354 to produce a set of unique values. The unique values are encoded at 358 to produce encoded values, thereby masking sensitive information. At 362, in some implementations, one or more regular expression (RegEx) operations are computed on the encoded values to produce a set of matches, where only the matches are kept. At 366, the encoded values are tokenized, e.g., using n-grams, byte-pair encoding (BPE), or the like to produce tokens. In an illustrative example, tokens can be “John” or “@gmail.com”, or even subsets of such strings like “Joh” or “@gm”, i.e., common values which do not identify a particular individual. At 370, the tokens are processed to produce embeddings, e.g., using large language models (LLMs) or other appropriate models.

In some other implementations, preprocessing operations also or alternatively include:
Classifying data elements, only returning categories matched
Generating numerical statistics while preventing exposure of sensitive numerical information like revenue pipeline, revenue, profits, etc.

In some implementations, a data discovery agent or a preprocessor service is configured to keep any transformations such as derivatives that occur more than a designated number of times across the unique set of values, e.g., more than 20 times.

Often, it is desirable that no piece of information stored by a data privacy system is attributable back to an individual. Also, it is often desirable that no such information be used to compromise the customer organization or any entity associated with the customer organization. In some implementations, a data discovery agent is configured to anonymize data, for instance, using irreversible operations, which can include encoding operations and sometimes hashing operations.

FIG. 4B shows an example of an anonymization process 400B. In the example of FIG. 4B, at 404, values are encoded, e.g., with ‘a’ for alphabetic (alpha) characters and ‘d’ for numeric characters. Any other characters remain unchanged, including periods, dashes and the like. Examples:
i. Phone number: ddd-ddd-dddd, +ddddddddddd, etc.
ii. Emails: aaa.aaaaaaa+ddd@aaaaa.aaa
iii. Usernames: aaaaadddd, _aaaa, etc.

By encoding the alphanumeric characters, patterns used via regular expressions are preserved, while still being able to use other non-alphanumeric characters for further classification. The occurrence and positions of special characters can help distinguish between phone numbers, social security numbers, bank account numbers, etc.

In FIG. 4B, at 412, k-shingles are computed. In one example, Jo: f1, Ma: f2, etc., where k=2 and fi represents the frequency, and the values are greater than 1 to avoid uniquely identifying bigrams. At 416, these shingles can then be converted to bit vectors where, e.g., 1=an occurrence of a shingle, and 0=no occurrence of a shingle. A bit vector representation can thus fit in 2-4 bytes (16-32 bits) for k>=2 and k<=6. At 420, using the shingles, Jaccard similarities are computed against known datasets. These similarities can be used as a feature. For example, a similarity can be computed against a signature vector computed from names of people in Wikipedia, which facilitates scaling to different languages. In some implementations, hashes of the shingles are computed, for instance, when it is desirable to use k>4, since hashing can be performed down to 32 bits in some implementations. In some other implementations, using histograms of shingle distributions is sufficient to classify various data elements. Locality-sensitive hashing (LSH) such as minhashing can be used in some implementations.

In some implementations, data categories are incorporated to update a system report for a customer organization's inventory items identifiable through one or more data sources. The data privacy system can classify shared data and associate classified data with a customer organization's internal systems reports. In some implementations, a classification promotion process exposes any predicted fields on the customer organization's associated system report. Optionally, if a data source can be mapped to an existing inventory item in the customer organization's inventory, then the associated system report will be updated to include the newly classified fields.

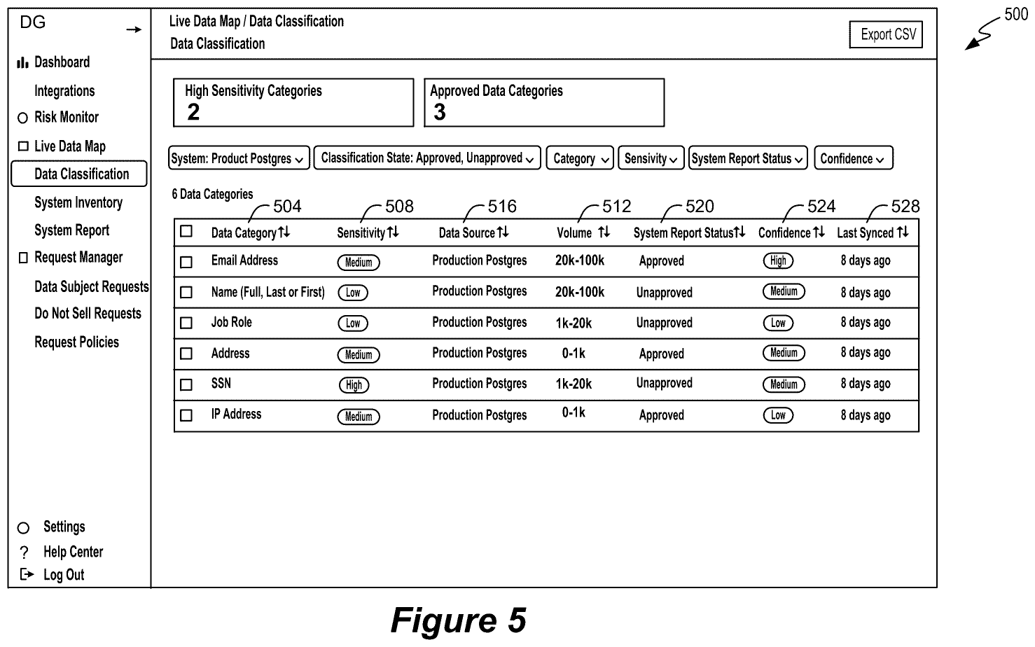

FIG. 5 shows an example of a data classification dashboard 500 in the form of an interactive graphical user interface (GUI). In FIG. 5, automated data category updates are shown. As new categories 504 such as email address, name, job role, address, social security number and IP address are detected, an interactive system report can be automatically updated with the newly detected categories, as shown in FIG. 5. In this way, privacy managers having permission through the customer organization to view the report can be alerted and able to review the updated information. Reviews can be done at the category level, without having to paginate through thousands of data elements. Once approved, such system reports can automatically inform RoPAs and privacy impact assessments. System reports can provide a focus on summarizing risk based on categories found as well as sensitivities of the categories. That is, under some laws, some categories of personal data are considered sensitive or higher risk. For instance, in FIG. 5, categories 504 have corresponding sensitivities 508 of ‘high,’ ‘medium’ or ‘low.’ In FIG. 5, volumes of findings 512 corresponding to categories 504 also can be indicated. The categories 504 also have corresponding data sources 516, system report status 520 (e.g., approved or unapproved), confidence 524 (e.g., high, medium or low) and last synced timeframe 528.

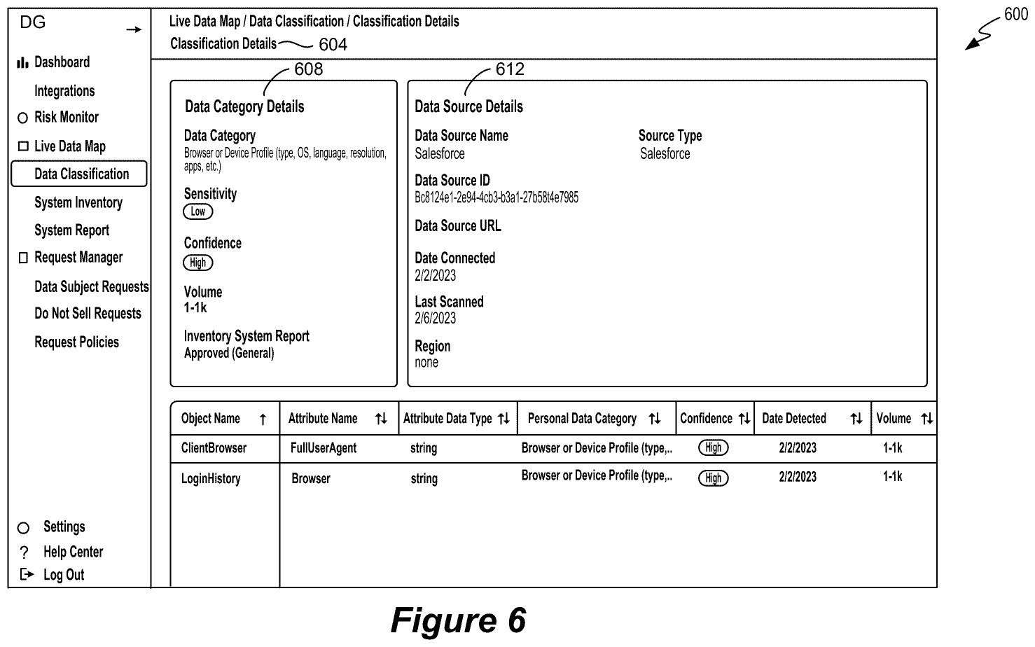

FIG. 6 shows an example of a classification details dashboard 600 in the form of an interactive GUI. In FIG. 6, users associated with a customer organization can drill down to see which specific fields or data elements within a given data source contain a specific category. In this example, classification details 604 include data category details 608 for a particular data category as well as data source details 612 for a particular data source corresponding to that data category.

In some implementations, a taxonomy classification is used to associate a classified data element with a system report. The taxonomy classification can prevent exposure of a data category on the system report, while letting the customer organization know that the data category was classified and that the relevant system report was found. In addition, the reviewed state of the exposed data category can be tracked. For instance, when a user saves the system report, a reviewed flag can be set. In some implementations, the exposure of the data category can be performed by creating a data category response, which causes the data category to appear as checked on the system report. These computations, along with taxonomy classification creation, can be performed as part of classification promotion, in some implementations.

The following provides an example for implementing data discovery techniques, for instance, when one or more data sources of a customer organization are in the form of relational databases such as MySQL.

Configuring a scanner can include: configuring each data source to be scanned, creating data source secret(s), and obtaining and configuring an API key provided by the data privacy system. In this example, these operations are performed using an environment variable or other agent configuration. Regarding connectors, in this example, each data source has its own configuration represented in the agent configuration. Regarding secrets, in this example, each connector uses specific credentials. In some implementations, it is recommended that a new user with read-only permissions be created in the customer network. Connecting to sandboxes or read-replicas also is recommended to avoid disrupting production operations. For a scanner to talk with the data privacy app, the scanner uses an API key to authorize requests. For instance, this API key can be stored in a secret under a token field. In the configuration, a field can be set with the location of the secret created.

An example of environment variables for running a scanner is provided in the following environment variable configuration template:

```
AGENT_CONFIG=′{
“customer_domain”: “<hostname>”,
  “credentials_location”: “<secret location>”, # vault location of API Key
  “platform”: {
    “credentials_manager”: {
      “provider”:
“<AWSSSMParameterStore|AWSSecretsManager|JSONFile|GCP|AzureKeyVault>”,
      “options”: {
        “optional”: “some modules may have required fields, e.g. GCP should have
project_id: <project id>, azure needs ‘secret_vault’”,
      }
    }
  }
}′
```

In the above template, the ‘customer_domain’ is a customer domain registered with the data privacy system. In this example, the ‘credentials_location’ identifies a value in a vault such as an AWS secrets manager ARN for the credentials used to make callback requests to the API of the data privacy system. In this example, ‘platform’ identifies the secrets/credentials and cloud storage platforms used to deploy the scanner. ‘Platform’ uses a field in this example: ‘credentials_manager’.

Some implementations provide a process, a non-transitory computer-readable medium, and/or a system implementing a data discovery agent in a network associated with a customer organization of a data privacy management system. Some examples can include establishing or using one or more connections with one or more data sources storing private data of the customer organization. The one or more data sources can be scanned to obtain scanned data from the private data. The scanned data can be preprocessed, including anonymizing the scanned data, to obtain preprocessed data for use by one or more classification operations. The preprocessed data can be shared with the data privacy management system.

In some examples, the data discovery agent is configured to be deployed and executed as one or more tasks in a network associated with the customer organization. The one or more tasks can be configured to be scheduled for execution using a designated containerization platform.

Some examples include obtaining a reference to a location of a secrets vault of the customer organization, and accessing, from the secrets vault, one or more keys associated with the data privacy management system, the one or more keys configured to be processed to authenticate and authorize a data discovery agent.

In some examples, establishing or using the one or more connections with the one or more data sources includes processing one or more credentials stored in a secrets vault of the customer organization.

In some examples, scanning the one or more data sources to obtain the scanned data from the private data includes sampling a designated number of database records stored in one or more databases.

In some examples, scanning the one or more data sources to obtain the scanned data from the private data includes retrieving one or more schemas and related metadata identifying one or more of: one or more databases, one or more tables, one or more columns, one or more data types, or one or more record counts.

In some examples, the scanned data includes personal data of individuals associated with the customer organization, the personal data including one or more of: phone numbers, email addresses, usernames, social security numbers, or bank account numbers.

In some examples, anonymizing the scanned data includes encoding the scanned data to obtain encoded data. For instance, encoding the scanned data can include: substituting a first character for alphabetic characters, and substituting a second character different from the first character for numeric characters.

In some examples, preprocessing the scanned data includes: computing shingles, converting the shingles to bit vectors with a first bit value indicating occurrence of a shingle and a second bit value indicating no occurrence of a shingle, and computing, using the bit vectors, jaccard similarities against identified datasets, the jaccard similarities serving as a feature of the preprocessed data. In some instances, preprocessing the scanned data further includes computing hashes of the shingles.

In some examples, preprocessing the scanned data includes, for a data element: deduping one or more values to produce a set of unique values, encoding the unique values to produce encoded values, performing one or more regular expression (RegEx) operations on the encoded values to produce a set of matches, tokenizing the encoded values to produce tokens, and generating embeddings using the tokens.

In some examples, sharing the preprocessed data with the data privacy management system includes: posting the preprocessed data through hypertext transfer protocol secure (HTTPS) to an application programming interface (API) provided by the data privacy management system, the API being authenticatable using a token provided by the data privacy management system.

In some examples, the preprocessed data includes one or more of: metadata, classification features, or anonymized data.

Some implementations provide a process, a non-transitory computer-readable medium, and/or a system including one or more memory devices in communication with one or more processors. Some examples can include obtaining anonymized data elements shared by a data discovery agent deployed in a network associated with a customer organization of a data privacy management system. One or more classification operations can be performed on the shared data elements to obtain classified data elements. One or more classification promotion operations can be performed on the classified data elements to obtain promoted data elements.

In some examples, performing the one or more classification operations includes mapping, using one or more classification models, the shared data elements to a plurality of categories. For instance, one or more new categories can be detected, and the plurality of categories can be updated to include the one or more new categories.

In some examples, performing the one or more classification operations includes: classifying, in a first phase, at least a portion of the shared data elements associated with a set of canonical data systems, and classifying, in a second phase, additional shared data elements at a designated cadence based on a customer configuration.

In some examples, performing the one or more classification operations includes processing histograms of shingle distributions.

In some examples, performing the one or more classification promotion operations includes: identifying classified data elements having a reviewed state, and designating the identified data elements as having an external promoted state.

In some examples, obtaining the shared data elements includes enqueuing the shared data elements in a queue.

Some examples further include generating or updating an internal system report for the customer organization based on the classified data elements. For instance, generating or updating the internal system report based on the classified data elements can include exposing, for the customer organization, one or more predicted fields in the internal system report. Also or alternatively, generating or updating the internal system report based on the classified data elements can include: mapping a data source to an existing inventory item of the customer organization, and including one or more classified fields in the internal system report.

It should be noted that, despite references to particular computing paradigms and software tools herein, computing device program instructions on which various implementations are based may correspond to any of a wide variety of programming languages, software tools and data formats, and be stored in any type of non-transitory computer-readable media or memory device(s), and may be executed according to a variety of computing models including, for example, a client/server model, a peer-to-peer model, on a stand-alone computing device, or according to a distributed computing model in which various functionalities may be effected or employed at different locations. In addition, references to particular protocols herein are merely by way of example. Suitable alternatives known to those of skill in the art may be employed.

Computing devices implementing systems, apparatus, modules and engines described herein have components including one or more processors, memory devices, input/output systems, etc. electrically coupled with each other, either directly or indirectly, and in communication with each other, either directly or indirectly, for operative couplings. Such computing devices can implement client systems as well as server systems. For instance, computer program code can be run using a processor in the form of a central processing unit such as an Intel processor or the like. Data and code can be stored locally on the computing device on computer-readable media, examples of which are described in greater detail herein. In some alternatives, portions of data and code can be stored on other computing devices in a network. A computing device can be implemented to have a processor system with a combination of processors. An input system of the computing device may be any combination of input devices, such as one or more keyboards, mice, trackballs, scanners, cameras, and/or interfaces to networks. An output system of the computing device may be any combination of output devices, such as one or more monitors, printers, and/or interfaces to networks.

Any of the modules, models, engines and operations described herein may be implemented at least in part as software code to be executed by a processor using any suitable computer language such as but not limited to C, Go, Java, and C++, by way of example only. The software code may be stored as a series of instructions or commands on a non-transitory computer-readable medium. Suitable computer-readable media include random access memory (RAM), read only memory (ROM), a magnetic medium such as a hard-drive or a floppy disk, an optical medium such as a compact disk (CD) or DVD (digital versatile disk), flash memory, and the like. The computer-readable medium may be any combination of such storage devices. Computer-readable media encoded with the software/program code may be part of a computer program product and may be packaged with a compatible computing device such as a client system or a server system as described above or provided separately from other devices. Any such computer-readable medium may reside on or within a single computing device or an entire computer system and may be among other computer-readable media within a system or network. A computing device may include a monitor, printer, or other suitable display for providing any of the reports or results mentioned herein to a user.

Any of the above implementations may be used alone or together in any combination. Although various implementations may have been motivated by various deficiencies with the prior art, which may be discussed or alluded to in one or more places herein, the implementations do not necessarily address any of these deficiencies. Some implementations may only partially address some deficiencies or just one deficiency that may be discussed, and some implementations may not address any of these deficiencies.

While the subject matter of this disclosure has been particularly shown and described with reference to specific implementations thereof, it will be understood by those skilled in the art that changes in the form and details of the disclosed implementations may be made without departing from the spirit or scope of this disclosure. Finally, although various advantages have been discussed herein with reference to various implementations, it will be understood that the scope should not be limited by reference to such advantages. Rather, the scope should be determined with reference to the appended claims.

What is claimed is:

1. A process implementing a data discovery agent in a network associated with a customer organization of a data privacy management system, the process comprising:
establishing or using one or more connections with one or more data sources storing private data of the customer organization;
scanning the one or more data sources to obtain scanned data from the private data;
preprocessing the scanned data, including anonymizing the scanned data, to obtain preprocessed data for use by one or more classification operations; and
sharing the preprocessed data with the data privacy management system.

2. The process of claim 1, further comprising:
obtaining a reference to a location of a secrets vault of the customer organization; and
accessing, from the secrets vault, one or more keys associated with the data privacy management system, the one or more keys configured to be processed to authenticate and authorize the data discovery agent.

3. The process of claim 1, wherein establishing or using the one or more connections with the one or more data sources includes:
processing one or more credentials stored in a secrets vault of the customer organization.

4. The process of claim 1, wherein scanning the one or more data sources to obtain the scanned data from the private data includes:
retrieving one or more schemas and related metadata identifying one or more of: one or more databases, one or more tables, one or more columns, one or more data types, or one or more record counts.

5. The process of claim 1, wherein anonymizing the scanned data includes:
encoding the scanned data to obtain encoded data.

6. The process of claim 5, wherein encoding the scanned data includes:
substituting a first character for alphabetic characters, and
substituting a second character different from the first character for numeric characters.

7. The process of claim 1, wherein preprocessing the scanned data includes:
computing shingles,
converting the shingles to bit vectors with a first bit value indicating occurrence of a shingle and a second bit value indicating no occurrence of a shingle, and
computing, using the bit vectors, jaccard similarities against identified datasets, the jaccard similarities serving as a feature of the preprocessed data.

8. The process of claim 7, wherein preprocessing the scanned data further includes:
computing hashes of the shingles.

9. The process of claim 1, wherein preprocessing the scanned data includes, for a data element:
deduping one or more values to produce a set of unique values,
encoding the unique values to produce encoded values,
performing one or more regular expression (RegEx) operations on the encoded values to produce a set of matches,
tokenizing the encoded values to produce tokens, and
generating embeddings using the tokens.

10. The process of claim 1, wherein sharing the preprocessed data with the data privacy management system includes:
posting the preprocessed data through hypertext transfer protocol secure (HTTPS) to an application programming interface (API) provided by the data privacy management system, the API being authenticatable using a token provided by the data privacy management system.

11. A non-transitory computer-readable medium storing program code capable of being executed by one or more processors, the program code comprising instructions configured to cause:
establishing or using one or more connections with one or more data sources storing private data of a customer organization of a data privacy management system;
scanning the one or more data sources to obtain scanned data from the private data;
preprocessing the scanned data, including anonymizing the scanned data, to obtain preprocessed data for use by one or more classification operations; and
sharing the preprocessed data with the data privacy management system.

12. The non-transitory computer-readable medium of claim 11, wherein the program code is configured to be deployed and executed as one or more tasks in a network associated with the customer organization.

13. The non-transitory computer-readable medium of claim 12, wherein the one or more tasks is configured to be scheduled for execution using a designated containerization platform.

14. The non-transitory computer-readable medium of claim 11, the instructions further configured to cause:
obtaining a reference to a location of a secrets vault of the customer organization; and
accessing, from the secrets vault, one or more keys associated with the data privacy management system, the one or more keys configured to be processed to authenticate and authorize a data discovery agent.

15. The non-transitory computer-readable medium of claim 11, wherein establishing or using the one or more connections with the one or more data sources includes:
processing one or more credentials stored in a secrets vault of the customer organization.

16. The non-transitory computer-readable medium of claim 11, wherein scanning the one or more data sources to obtain the scanned data from the private data includes:
sampling a designated number of database records stored in one or more databases.

17. The non-transitory computer-readable medium of claim 11, wherein scanning the one or more data sources to obtain the scanned data from the private data includes:
retrieving one or more schemas and related metadata identifying one or more of: one or more databases, one or more tables, one or more columns, one or more data types, or one or more record counts.

18. The non-transitory computer-readable medium of claim 11, wherein the scanned data includes personal data of individuals associated with the customer organization, the personal data including one or more of: phone numbers, email addresses, usernames, social security numbers, or bank account numbers.

19. The non-transitory computer-readable medium of claim 11, wherein anonymizing the scanned data includes:
encoding the scanned data to obtain encoded data.

20. The non-transitory computer-readable medium of claim 19, wherein encoding the scanned data includes:
substituting a first character for alphabetic characters, and
substituting a second character different from the first character for numeric characters.

21. The non-transitory computer-readable medium of claim 11, wherein preprocessing the scanned data includes:
computing shingles,
converting the shingles to bit vectors with a first bit value indicating occurrence of a shingle and a second bit value indicating no occurrence of a shingle, and
computing, using the bit vectors, jaccard similarities against identified datasets, the jaccard similarities serving as a feature of the preprocessed data.

22. The non-transitory computer-readable medium of claim 21, wherein preprocessing the scanned data further includes:
computing hashes of the shingles.

23. The non-transitory computer-readable medium of claim 11, wherein preprocessing the scanned data includes, for a data element:
deduping one or more values to produce a set of unique values,
encoding the unique values to produce encoded values,
performing one or more regular expression (RegEx) operations on the encoded values to produce a set of matches,
tokenizing the encoded values to produce tokens, and
generating embeddings using the tokens.

24. The non-transitory computer-readable medium of claim 11, wherein sharing the preprocessed data with the data privacy management system includes:
posting the preprocessed data through hypertext transfer protocol secure (HTTPS) to an application programming interface (API) provided by the data privacy management system, the API being authenticatable using a token provided by the data privacy management system.

25. The non-transitory computer-readable medium of claim 11, wherein the preprocessed data includes one or more of: metadata, classification features, or anonymized data.

26. A system comprising:
one or more memory devices; and
one or more processors configured to cause:
establishing or using one or more connections with one or more data sources storing private data of a customer organization of a data privacy management system;
scanning the one or more data sources to obtain scanned data from the private data;
preprocessing the scanned data, including anonymizing the scanned data, to obtain preprocessed data for use by one or more classification operations; and
sharing the preprocessed data with the data privacy management system.

27. The system of claim 26, wherein a data discovery agent is configured to be deployed and executed as one or more tasks in a network associated with the customer organization.

28. The system of claim 27, wherein the one or more tasks is configured to be scheduled for execution using a designated containerization platform.

29. The system of claim 26, the one or more processors further configured to cause:
obtaining a reference to a location of a secrets vault of the customer organization; and
accessing, from the secrets vault, one or more keys associated with the data privacy management system, the one or more keys configured to be processed to authenticate and authorize a data discovery agent.

30. The system of claim 26, wherein establishing or using the one or more connections with the one or more data sources includes:
processing one or more credentials stored in a secrets vault of the customer organization.

31. The system of claim 26, wherein scanning the one or more data sources to obtain the scanned data from the private data includes:
sampling a designated number of database records stored in one or more databases.

32. The system of claim 26, wherein scanning the one or more data sources to obtain the scanned data from the private data includes:
retrieving one or more schemas and related metadata identifying one or more of: one or more databases, one or more tables, one or more columns, one or more data types, or one or more record counts.

33. The system of claim 26, wherein the scanned data includes personal data of individuals associated with the customer organization, the personal data including one or more of: phone numbers, email addresses, usernames, social security numbers, or bank account numbers.

34. The system of claim 26, wherein anonymizing the scanned data includes:
encoding the scanned data to obtain encoded data.

35. The system of claim 34, wherein encoding the scanned data includes:
substituting a first character for alphabetic characters, and
substituting a second character different from the first character for numeric characters.

36. The system of claim 26, wherein preprocessing the scanned data includes:
computing shingles,
converting the shingles to bit vectors with a first bit value indicating occurrence of a shingle and a second bit value indicating no occurrence of a shingle, and
computing, using the bit vectors, jaccard similarities against identified datasets, the jaccard similarities serving as a feature of the preprocessed data.

37. The system of claim 36, wherein preprocessing the scanned data further includes:
computing hashes of the shingles.

38. The system of claim 26, wherein preprocessing the scanned data includes, for a data element:
deduping one or more values to produce a set of unique values,
encoding the unique values to produce encoded values,
performing one or more regular expression (RegEx) operations on the encoded values to produce a set of matches,
tokenizing the encoded values to produce tokens, and
generating embeddings using the tokens.

39. The system of claim 26, wherein sharing the preprocessed data with the data privacy management system includes;
posting the preprocessed data through hypertext transfer protocol secure (HTTPS) to an application programming interface (API) provided by the data privacy management system, the API being authenticatable using a token provided by the data privacy management system.

40. The system of claim 26, wherein the preprocessed data includes one or more of: metadata, classification features, or anonymized data.

41. A data privacy management system comprising:
one or more memory devices; and
one or more processors configured to cause:
obtaining anonymized data elements shared by a data discovery agent deployed in a network associated with a customer organization of the data privacy management system,
performing one or more classification operations on the shared data elements to obtain classified data elements, and
performing one or more classification promotion operations on the classified data elements to obtain promoted data elements.

42. The system of claim 41, wherein performing the one or more classification operations includes:
mapping, using one or more classification models, the shared data elements to a plurality of categories.

43. The system of claim 42, the one or more processors further configured to cause;
detecting one or more new categories, and
updating the plurality of categories to include the one or more new categories.

44. The system of claim 41, wherein performing the one or more classification operations includes:
classifying, in a first phase, at least a portion of the shared data elements associated with a set of canonical data systems, and
classifying, in a second phase, additional shared data elements at a designated cadence based on a customer configuration.

45. The system of claim 41, wherein performing the one or more classification operations includes:
processing histograms of shingle distributions.

46. The system of claim 41, wherein performing the one or more classification promotion operations includes:
identifying classified data elements having a reviewed state, and
designating the identified data elements as having an external promoted state.

47. The system of claim 41, wherein obtaining the shared data elements includes: enqueuing the shared data elements in a queue.

48. The system of claim 41, the one or more processors further configured to cause;
generating or updating an internal system report for the customer organization based on the classified data elements.

49. The system of claim 48, wherein generating or updating the internal system report based on the classified data elements includes:
exposing, for the customer organization, one or more predicted fields in the internal system report.

50. The system of claim 48, wherein generating or updating the internal system report based on the classified data elements includes:
mapping a data source to an existing inventory item of the customer organization, and
including one or more classified fields in the internal system report.

51. A non-transitory computer-readable medium storing program code capable of being executed by one or more processors, the program code comprising instructions configured to cause:
obtaining anonymized data elements shared by a data discovery agent deployed in a network associated with a customer organization of a data privacy management system,
performing one or more classification operations on the shared data elements to obtain classified data elements, and
performing one or more classification promotion operations on the classified data elements to obtain promoted data elements.

52. The non-transitory computer-readable medium of claim 51, wherein performing the one or more classification operations includes:
mapping, using one or more classification models, the shared data elements to a plurality of categories.

53. The non-transitory computer-readable medium of claim 52, the instructions further configured to cause:
detecting one or more new categories, and
updating the plurality of categories to include the one or more new categories.

54. The non-transitory computer-readable medium of claim 51, wherein performing the one or more classification operations includes:
classifying, in a first phase, at least a portion of the shared data elements associated with a set of canonical data systems, and
classifying, in a second phase, additional shared data elements at a designated cadence based on a customer configuration.

55. The non-transitory computer-readable medium of claim 51, wherein performing the one or more classification operations includes:
processing histograms of shingle distributions.

56. The non-transitory computer-readable medium of claim 51, wherein performing the one or more classification promotion operations includes:
identifying classified data elements having a reviewed state, and
designating the identified data elements as having an external promoted state.

57. The non-transitory computer-readable medium of claim 51, wherein obtaining the shared data elements includes:
enqueuing the shared data elements in a queue.

58. The non-transitory computer-readable medium of claim 51, the instructions further configured to cause:
generating or updating an internal system report for the customer organization based on the classified data elements.

59. The non-transitory computer-readable medium of claim 58, wherein generating or updating the internal system report based on the classified data elements includes:
exposing, for the customer organization, one or more predicted fields in the internal system report.

60. The non-transitory computer-readable medium of claim 58, wherein generating or updating the internal system report based on the classified data elements includes:
mapping a data source to an existing inventory item of the customer organization, and
including one or more classified fields in the internal system report.

61. A process comprising:
obtaining anonymized data elements shared by a data discovery agent deployed in a network associated with a customer organization of a data privacy management system,
performing one or more classification operations on the shared data elements to obtain classified data elements, and
performing one or more classification promotion operations on the classified data elements to obtain promoted data elements.

62. The process of claim 61, wherein performing the one or more classification operations includes:
mapping, using one or more classification models, the shared data elements to a plurality of categories.

63. The process of claim 62, further comprising:
detecting one or more new categories, and
updating the plurality of categories to include the one or more new categories.

64. The process of claim 61, wherein performing the one or more classification operations includes:
classifying, in a first phase, at least a portion of the shared data elements associated with a set of canonical data systems, and
classifying, in a second phase, additional shared data elements at a designated cadence based on a customer configuration.

65. The process of claim 61, wherein performing the one or more classification operations includes:
processing histograms of shingle distributions.

66. The process of claim 61, wherein performing the one or more classification promotion operations includes:
identifying classified data elements having a reviewed state, and
designating the identified data elements as having an external promoted state.

67. The process of claim 61, wherein obtaining the shared data elements includes: enqueuing the shared data elements in a queue.

68. The process of claim 61, further comprising:
generating or updating an internal system report for the customer organization based on the classified data elements.

69. The process of claim 68, wherein generating or updating the internal system report based on the classified data elements includes:
exposing, for the customer organization, one or more predicted fields in the internal system report.

70. The process of claim 68, wherein generating or updating the internal system report based on the classified data elements includes:
mapping a data source to an existing inventory item of the customer organization, and
including one or more classified fields in the internal system report.
